(19) United States
(12) Patent Application Publication
(10) Pub. No.: US 2024/0355523 A1
(43) Pub. Date: Oct. 24, 2024

(54) INDUCTOR

(71) Applicant: Panasonic Intellectual Property Management Co., Ltd., Osaka (JP)

(72) Inventors: KIYOSHI TAKAGI, Hyogo (JP); YUSUKE NAKAMURA, Hyogo (JP); MASAHIRO ENOMOTO, Osaka (JP); HIROSHI TOMITA, Nara (JP)

(21) Appl. No.: 18/682,904

(22) PCT Filed: Aug. 25, 2022
(86) PCT No.: PCT/JP2022/032005

§ 371 Date: Feb. 10, 2024

(30) Foreign Application Priority Data
Sep. 16, 2021 (JP) 2021-150670

(51) Int. Cl. H01F 17/06; H01F 27/255

(52) U.S. Cl. CPC H01F 17/06; H01F 27/255

(57) ABSTRACT

An object is to obtain an inductor that has a low inductance and can withstand a large current. Inductor includes magnetic core obtained by mixing a powder magnetic material and a binder and compression-molding a mixture, and flat conductive wire embedded in magnetic core and extending linearly with an end portion protruding from an end surface of magnetic core. When viewed from a top surface, magnetic core includes central portion covering flat conductive wire, side surface portions provided on both sides of central portion, and tapered portions provided between central portion and side surface portions, and a thickness of side surface portions is thinner than a thickness of central portion.

### TECHNICAL FIELD

The present disclosure relates to an inductor used in various electronic devices.

### BACKGROUND ART

An inductor used for a power supply is required to have a low inductance and withstand a large current as a switching frequency of a power supply circuit increases to higher frequency. For this reason, an inductor is sometimes obtained by embedding a flat conductive wire in a magnetic core obtained by mixing a powder magnetic material and a binder and compression-molding a mixture.

As prior art citation information on the above-mentioned inductor, for example, PTL 1 is known.

### CITATION LIST

### Patent Literature

PTL 1: WO 2006/070544 A

### SUMMARY OF THE INVENTION

However, as a use of larger current progresses further, a cross-sectional area of the flat conductive wire is required to increase, resulting in an increase in thickness. As a thickness of the flat conductive wire increases with respect to a thickness of the magnetic core, a difference occurs in the magnetic powder density between a part where the flat conductive wire exists and a part where the flat conductive wire does not exist when the magnetic core is compression-molded as viewed from a top surface, and sufficient electrical characteristics cannot be obtained.

An object of the present disclosure is to provide an inductor that has a low inductance and can withstand a larger current.

An inductor according to the present disclosure includes: a magnetic core obtained by mixing a powder magnetic material and a binder and compression-molding a mixture; and a flat conductive wire embedded in the magnetic core and extending linearly with an end portion protruding from an end surface of the magnetic core. When viewed from a top surface, the magnetic core includes a central portion covering the flat conductive wire, side surface portions provided on both sides of the central portion, and tapered portions provided between the central portion and the side surface portions, and a thickness of the side surface portions is thinner than a thickness of the central portion.

With the above configuration, when pressure is applied from a vertical direction for compression-molding, the tapered portions cause the magnetic powder to flow toward the flat conductive wire, thus making the magnetic powder density around the flat conductive wire uniform and improving the electrical characteristics.

### BRIEF DESCRIPTION OF THE DRAWINGS

FIG. 1 is a perspective view of an inductor according to an exemplary embodiment of the present disclosure.

FIG. 2A is an external view of the inductor according to an exemplary embodiment of the present disclosure as viewed from a top surface.

FIG. 2B is an external view of the inductor according to an exemplary embodiment of the present disclosure as viewed from a side surface.

FIG. 2C is an external view of the inductor according to an exemplary embodiment of the present disclosure as viewed from an end surface.

FIG. 3 is a cross-sectional view of the inductor according to an exemplary embodiment of the present disclosure.

FIG. 4 is a cross-sectional view of the inductor according to an exemplary embodiment of the present disclosure.

FIG. 5 is a cross-sectional view of a mold used in an inductor manufacturing process according to an exemplary embodiment of the present disclosure.

### DESCRIPTION OF EMBODIMENT

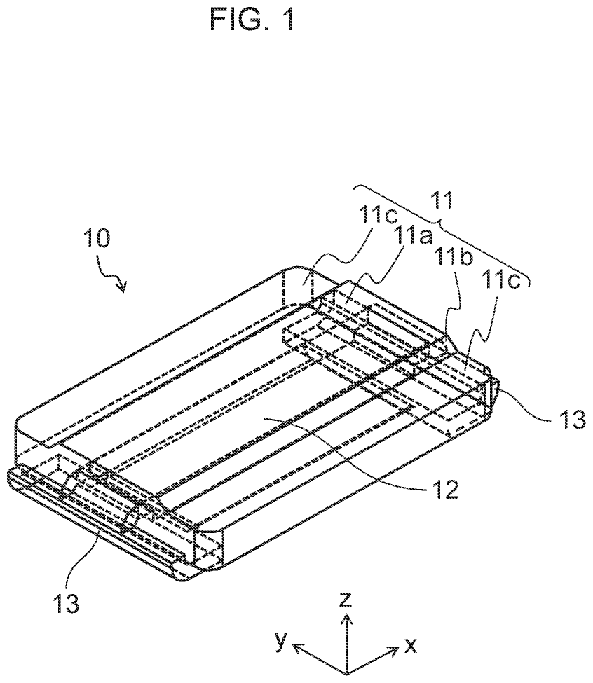

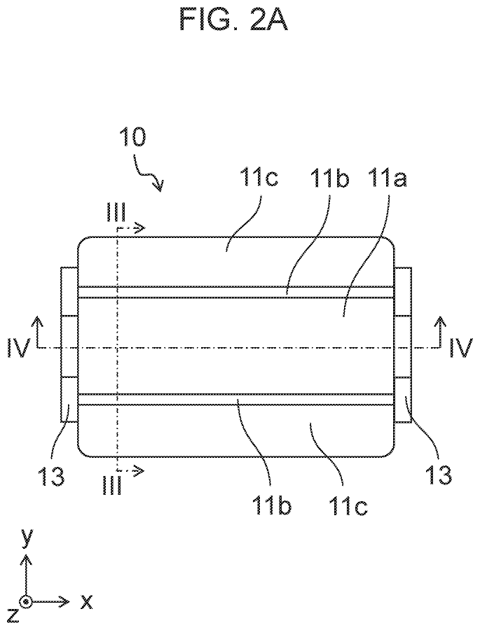

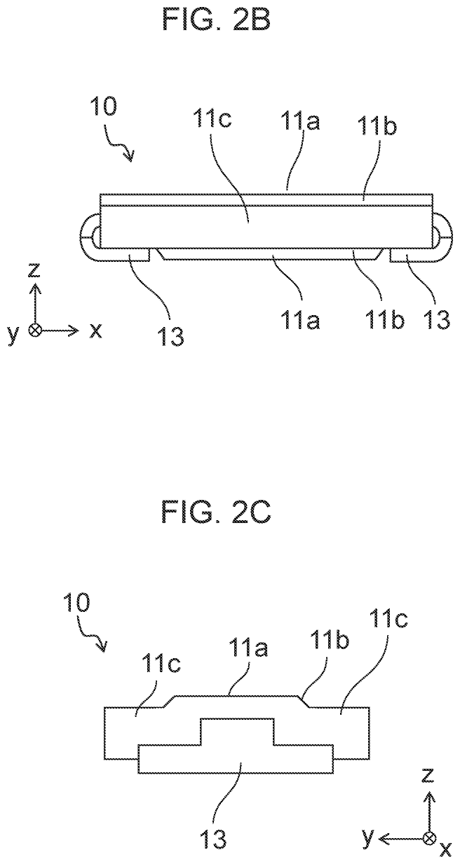

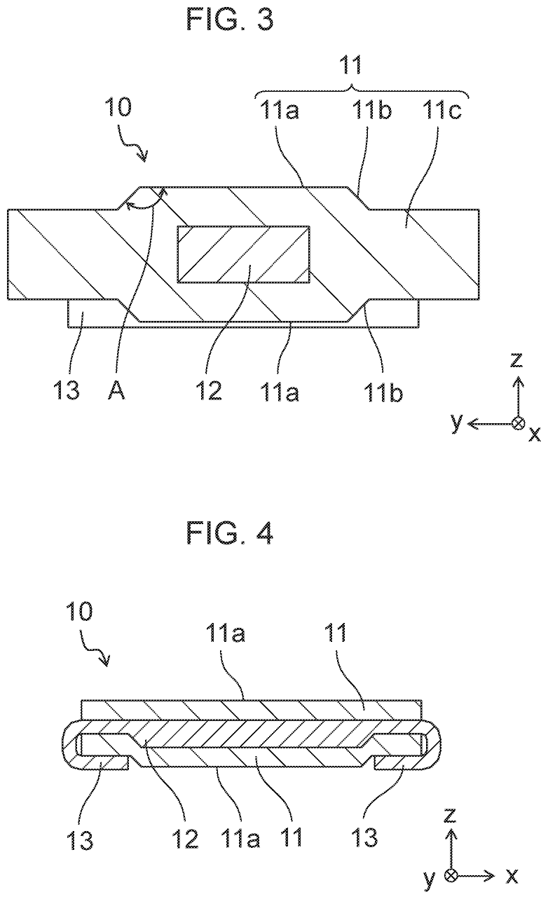

Hereinafter, inductor 10 according to an exemplary embodiment of the present disclosure will be described with reference to the drawings. FIG. 1 is a perspective view of inductor 10, FIGS. 2A to 2C are external views of inductor 10, and FIGS. 3 and 4 are cross-sectional views of inductor 10 according to an exemplary embodiment of the present disclosure. FIG. 2A is an external view as viewed from a top surface, FIG. 2B is an external view as viewed from a side surface, and FIG. 2C is an external view as viewed from an end surface. FIG. 3 is a cross-sectional view taken along a plane perpendicular to an extending direction of flat conductive wire 12 (a cross-sectional view taken along line III-III in FIG. 2). FIG. 4 is a cross-sectional view taken along a plane including an extending direction of flat conductive wire 12 (a cross-sectional view taken along line IV-IV in FIG. 2). In FIGS. 1 to 4, an xyz orthogonal coordinate system is provided with an extending direction of flat conductive wire 12 as an x-axis, a direction from central portion 11a of magnetic core 11 toward side surface portion 11c as a y-axis, and a direction perpendicular to the x-axis and the y-axis as a z-axis.

Inductor 10 includes magnetic core 11 obtained by mixing and compression-molding a powder magnetic material made of Fe—Si—Cr and a binder made of silicone resin, and flat conductive wire 12 embedded in magnetic core 11. Outer dimensions of magnetic core 11 are approximately 4.3 mm in width, approximately 7 mm in length, and approximately 1.2 mm in height. Flat conductive wire 12 is formed by punching out a copper plate with a thickness of approximately 0.5 mm into a width of approximately 1.2 mm, and is embedded in magnetic core 11 to linearly extend from one end surface to the other end surface of magnetic core 11. Flat conductive wire 12 protrudes from both end surfaces of magnetic core 11, and is bent from the end surfaces toward a bottom surface, thereby constituting external electrodes 13.

A thickness of flat conductive wire 12 decreases outward from near a part protruding from magnetic core 11 to approximately 0.25 mm. The thickness is reduced by pressing a side of flat conductive wire 12 facing the bottom surface of magnetic core 11 with a press mold. This makes it easy to bend the part of flat conductive wire 12 protruding from each of the end surfaces of magnetic core 11 toward the bottom surface of magnetic core 11.

In magnetic core 11, central portion 11a, which covers flat conductive wire 12 along an extending direction as viewed from the top surface, is the thickest at approximately 1.2 mm thickness, tapered portions 11b along the extending direction of flat conductive wire 12 on both sides of central portion 11a are provided, and side surface portions 11c of approximately 0.8 mm thickness are provided on both sides thereof. That is, side surface portions 11c are thinner than central portion 11a. Here, a width of central portion 11a is approximately 1.9 mm, and a width of respective side surface portions 11c is approximately 1.0 mm. Note that covering flat conductive wire 12 along the extending direction means that the width of central portion 11a is made larger than a width perpendicular to the extending direction of flat conductive wire 12, and central portion 11a protrudes to both sides in a width direction of flat conductive wire 12.

An angle (A in FIG. 3) formed by central portion 11a and each of tapered portions 11b is set to approximately 135°. As the thickness of the flat conductive wire increases with respect to the thickness of the magnetic core, a difference is likely to occur in the magnetic powder density between a part where the flat conductive wire exists and a part where the flat conductive wire does not exist when the magnetic core is compression-molded as viewed from the top surface, and the part where the flat conductive wire does not exist has a smaller density. Whereas, according to an exemplary embodiment of the present disclosure, tapered portions 11b are provided between central portion 11a and side surface portions 11c, side surface portions 11c are thinner than central portion 11a. By setting the angle between each of tapered portions 11b and central portion 11a to approximately 135°, the magnetic powder density of side surface portions 11c is increased, and tapered portions 11b cause the magnetic powder to further flow near flat conductive wire 12, as a result, the magnetic powder density near flat conductive wire 12 can be improved. In this way, the magnetic powder density can be made uniform, and the electrical characteristics can be improved.

An angle formed by central portion 11a and each of tapered portions 11b is desirably between 110° and 160° inclusive. When the angle is smaller than 110° or larger than 160°, the tapered portion makes it difficult for the magnetic powder to flow near the flat conductive wire, making it difficult to achieve uniform magnetic powder density. Furthermore, it is more preferable that the angle formed by central portion 11a and each of tapered portions 11b is between 120° and 150° inclusive.

It is desirable that the thickness of flat conductive wire 12 is from 20% to 70% inclusive of the thickness of central portion 11a. When the thickness of flat conductive wire 12 is thinner than 20% of the thickness of central portion 11a, the effect of the technology according to the present disclosure is less likely to be effective, and when the thickness is thicker than 70%, the amount of magnetic material on the upper and lower sides of flat conductive wire 12 is reduced, resulting in deterioration of electrical characteristics.

Next, a method for manufacturing an inductor according to an exemplary embodiment of the present disclosure will be described. First, a copper plate is prepared, and the copper plate is punched out to form shapes that will become flat conductive wire 12 and external electrodes 13. At this time, a thickness of a part that will become external electrodes 13 may be thinner by partially pressing.

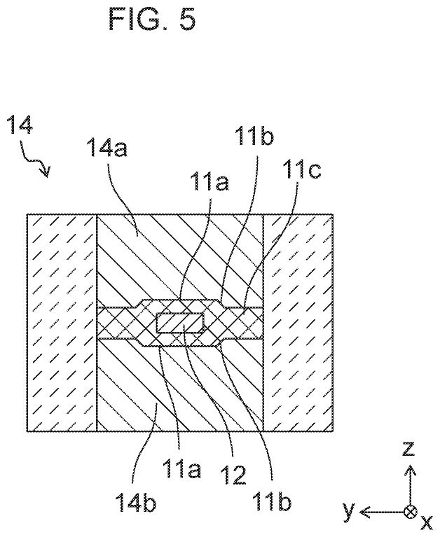

Next, a magnetic powder, which is a mixture of a powder magnetic material and a binder, and a flat conductive wire are placed in a mold and compression-molded. A cross-sectional view of mold 14 used at this time is shown in FIG. 5. That is, FIG. 5 is a cross-sectional view of mold 14 used in a manufacturing process of inductor 10 according to an exemplary embodiment of the present disclosure. In FIG. 5, an xyz orthogonal coordinate system is provided. The x-axis, the y-axis, and the z-axis are the same as those in FIGS. 1 to 4. In each of top punch 14a and bottom punch 14b of mold 14, central portion 11a, which covers flat conductive wire 12 along the extending direction as a shape of magnetic core 11 is viewed from the top surface, tapered portions 11b along the extending direction of flat conductive wire 12 on both sides of central portion 11a are provided, and side surface portions 11c are formed on both sides thereof. The parts of top punch 14a and bottom punch 14b forming tapered portions 11b are shaped obliquely to a part forming central portion 11a. In this way, when compression-molding is performed by top punch 14a and bottom punch 14b, areas forming tapered portions 11b are subjected to a force in a direction oblique to the vertical direction, thereby improving the magnetic powder density near flat conductive wire 12. According to the above exemplary embodiment, both top punch 14a and bottom punch 14b are provided with areas for forming tapered portions 11b, but either one may be provided.

The molded product is then removed from mold 14 and magnetic core 11 is hardened. Thereafter, solder dipping is performed on the parts that will become external electrodes, these parts are bent toward the bottom surface of magnetic core 11 to form external electrodes 13, and inductor 10 is obtained.

### INDUSTRIAL APPLICABILITY

The inductor according to the present disclosure can provide an inductor with low inductance that can withstand a larger current, and is industrially useful.

### REFERENCE MARKS IN THE DRAWINGS

10: inductor
11: magnetic core
11a: central portion
11b: tapered portion
11c: side surface portion
12: flat conductive wire
13: external electrode
14: mold
14a: top punch
14b: bottom punch

1. An inductor comprising:
a magnetic core obtained by mixing a powder magnetic material and a binder and compression-molding a mixture; and
a flat conductive wire embedded in the magnetic core and extending linearly with an end portion protruding from an end surface of the magnetic core, wherein
when viewed from a top surface, the magnetic core includes
a central portion covering the flat conductive wire,
side surface portions provided on both sides of the central portion, and
tapered portions each provided between the central portion and a corresponding one of the side surface portions, and
a thickness of each of the side surface portions is thinner than a thickness of the central portion.

2. The inductor according to claim 1, wherein the central portion and each of the tapered portions form an angle of between 110° and 160° inclusive.

3. The inductor according to claim 2, wherein the central portion and each of the tapered portions form an angle of between 120° and 150° inclusive.

4. The inductor according to claim 1, wherein the flat conductive wire has a thickness that is from 20% to 70% inclusive of the thickness of the central portion.
